(19) United States
(12) Patent Application Publication
(10) Pub. No.: US 2023/0167666 A1
(43) Pub. Date: Jun. 1, 2023

(54) SYSTEM AND METHOD FOR DECOUPLING OF A DOOR LINEAR ACTUATOR ASSEMBLY FOR A DAMAGE CONDITION

(71) Applicant: MAGNA CLOSURES INC., Newmarket (CA)

(72) Inventor: Ryan HERMAN, Aurora (CA)

(21) Appl. No.: 18/056,455

(22) Filed: Nov. 17, 2022

Related U.S. Application Data
(60) Provisional application No. 63/284,808, filed on Dec. 1, 2021.

(51) Int. Cl. E05F 15/40

(52) U.S. Cl. CPC E05F 15/40; E05Y 2900/531; E05Y 2800/252; E05Y 2600/62

(57) ABSTRACT

A system for releasably securing a linear actuator assembly to a vehicle closure panel comprising the linear actuator assembly coupled at one end to a door frame by a first pivot connection and coupled at a second end to a vehicle body by a second pivot connection, the actuator assembly having an extensible member configured for extension and retraction in order to facilitate opening and closing of the closure panel with respect to the vehicle body; and at least one of the pivot connections having an actuator connector connected to the extensible member and a body connector connected to either the vehicle body or the door frame, such that when in a coupled state a connection element secures the body connector to the actuator connector; and a disconnection mechanism for removing the connection element from the connectors in response to a detection of a damage event.

### CROSS-REFERENCE TO RELATED APPLICATION

This application claims priority from the benefit of the filing date of U.S. Provisional Patent Application No. 63/284,808 filed on Dec. 1, 2021, entitled “SYSTEM AND METHOD FOR DECOUPLING OF A DOOR LINEAR ACTUATOR ASSEMBLY FOR A DAMAGE CONDITION”, the contents of which are herein incorporated by reference.

### FIELD

The present disclosure relates to closure panel actuation systems.

### BACKGROUND

When a spindle (electric linear actuator such as a lead screw extendable and retractable) is used to actuate (e.g. open/close) a door/lift gate, there can be issues during crash events, or other system malfunctions such as damage to, or otherwise failure of, components. For example, a side impact to the vehicle can deform/damage the linear actuator (e.g. the lead screw), such that the door possibly could not be opened if the lead screw cannot extend/retract under power or by a manual door opening.

In terms of current state of the art linear actuator systems, normally either end of the spindle is directly and fixedly connected to the vehicle frame. This type of arrangement can however be problematic during a crash event. Any damage caused to the spindle mechanism (e.g. as a result of impact forces being transferred from the body/door of the vehicle to the spindle) could result in binding or otherwise malfunction of the spindle during opening or closing of the door post collision.

### SUMMARY

It is an object of the present invention to provide a linear actuator disconnection system and method to obviate or mitigate at least some of the above-presented disadvantages.

A first aspect provided is a system for releasably securing a linear actuator assembly to a vehicle closure panel comprising the linear actuator assembly coupled at one end to a door frame by a first pivot connection and coupled at a second end to a vehicle body by a second pivot connection, the actuator assembly having an extensible member configured for extension and retraction in order to facilitate opening and closing of the closure panel with respect to the vehicle body; and at least one of the pivot connections having an actuator connector connected to the extensible member and a body connector connected to either the vehicle body or the door frame, such that when in a coupled state a connection element secures the body connector to the actuator connector; and a disconnection mechanism for removing the connection element from the connectors in response to a detection of door malfunction.

A further aspect provided is a method for releasably securing a linear actuator assembly to a vehicle closure panel, the method comprising: providing the linear actuator assembly coupled at one end to a door frame by a first pivot connection and coupled at a second end to a vehicle body by a second pivot connection, at least one of the pivot connections having an actuator connector connected to the linear actuator assembly and a body connector connected to either the vehicle body or the door frame, such that when in a coupled state a connection element secures the body connector to the actuator connector; receiving an event signal indicating a door malfunction event; and instructing a disconnection mechanism for removing the connection element from the connectors in response to said event signal; wherein the at least one of the pivot connections is placed in a decoupled state by disengagment of the body connector from the actuator connector when the connection element is removed.

A further aspect provided is a system for releasably securing an actuator assembly (30) connected to a vehicle closure panel and to a vehicle body, the system comprising the actuator assembly coupled to the vehicle closure panel by a first connection and coupled at a second end to a vehicle body by a second connection, the actuator assembly having an extensible member configured for movement in order to facilitate opening and closing of the closure panel with respect to the vehicle body, wherein one of the connections has a coupled state to secure the actuator assembly to one of the vehicle closure panel and the vehicle body and has a decoupled state to unsecure the actuator assembly from one of the vehicle closure panel and the vehicle body, the decoupled state allowing the closure panel to open without the extensible member moving.

### BRIEF DESCRIPTION OF THE DRAWINGS

The foregoing and other aspects will now be described by way of example only with reference to the attached drawings, in which:

FIG. 1 is a perspective view of a vehicle closure panel coupled to a vehicle;

FIG. 2 is a further embodiment of the closure panel shown in FIG. 1;

FIG. 3 is a side view of an embodiment of the linear actuator assembly shown in FIG. 1;

FIG. 4 is an alternative embodiment of the linear actuator assembly shown in FIG. 1;

FIG. 5 is an enlarged view of the linear actuator assembly shown in FIG. 3, in a coupled state prior to crash detection;

FIG. 6 is an enlarged view of the linear actuator assembly shown in FIG. 3, in a coupled state once crash detection has occurred;

FIG. 7 is an enlarged view of the linear actuator assembly shown in FIG. 3, in a coupled state with initiation of a disconnection mechanism;

FIG. 8 is an enlarged view of the linear actuator assembly shown in FIG. 3, in a decoupled state post operation of the disconnection mechanism;

FIG. 9 shows a further embodiment as a plan view of the linear actuator assembly shown in FIG. 3 in a coupled state;

FIG. 10 shows the linear actuator assembly shown in FIG. 9 in a decoupled state;

FIG. 11 shows a cut away view of an example linear actuator of FIG. 3;

FIG. 12 is a cross sectional view of a further embodiment of the linear actuator of FIG. 3;

FIG. 13 is an example operation of the system of FIG. 1;

FIG. 14 is an alternative embodiment of the operation of FIG. 13; and

FIG. 15 is an alternative embodiment of the operation of FIG. 13.

### DETAILED DESCRIPTION

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

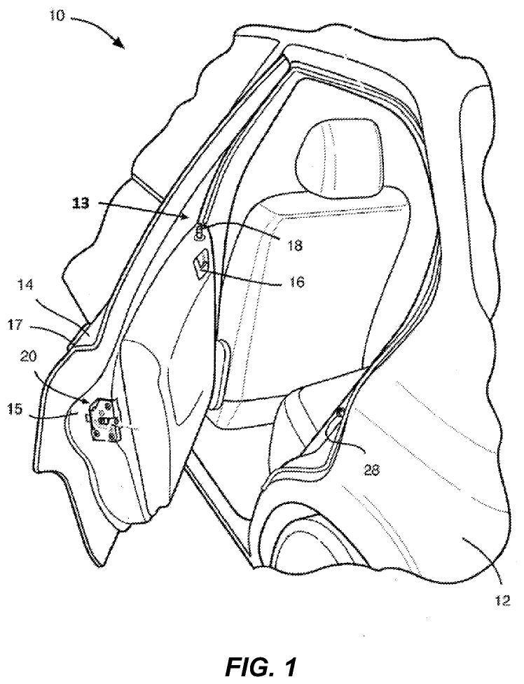

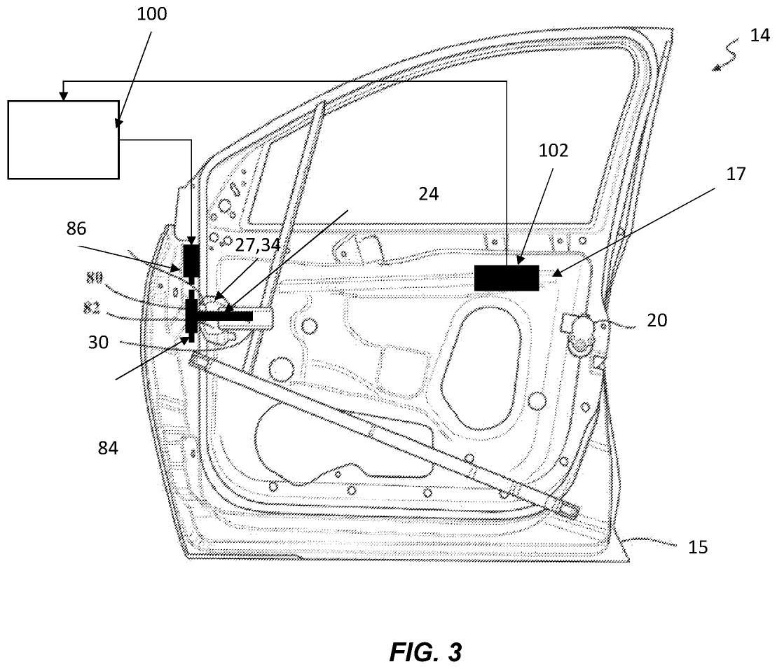

FIG. 1 is a perspective view of a vehicle 10 that includes a vehicle body 12 and at least one vehicle door 14 (also referred to as a closure panel 14). The vehicle closure panel 14 includes a latch 20 that is positioned on a door frame 15 of the vehicle closure panel 14, the latch 20 being releasably engageable with a striker 28 on the vehicle body 12 to releasably hold the vehicle closure panel 14 in a closed position. The frame 20 also supports a window 13 via a window regulator assembly mounted to the frame 15 of the vehicle closure panel 14. An outside closure panel handle 17 is provided for opening the latch 20 (i.e. for releasing the latch 20 from the striker 28) to open the vehicle closure panel 14, as well as to optionally operate an electrically powered actuator assembly 30, illustratively shown as a linear actuator assembly having a lead screw 24,140 and a motor 25 (see FIGS. 3, 11, 12 Further, the vehicle closure panel 14 has inside controls 16, 18 (e.g. door handle, door locking/unlocking tab, etc.) for operating the latch 20 and the electric linear actuator assembly 30. It is also recognized that that a key fob (not shown) or other presence sending controls (e.g. door presence sensor—not shown) can be used to activate the electric linear actuator assembly 30, as desired. Examples of actuator assembly 30 may include without limitation, of the type shown in U.S. patent application Ser. No. 14/930,735 titled “Swing door actuation system having a power swing door actuator and a control system”, in U.S. patent application Ser. No. 17/762,391 titled “Powered door unit optimized for servo control”, in U.S. patent application Ser. No. 16/200,777 titled “Swing Door Control Linkage”, in U.S. patent application Ser. No. 15/473,727 titled “Power swing door actuator with integrated door check mechanism”, in U.S. patent application Ser. No. 14/234,812 titled “Power swing door actuator”, in U.S. patent application Ser. No. 14/472,854 titled “Power door actuation system”, in U.S. patent application Ser. No. 15/884,582 titled “Power side door actuator with rotating drive nut”. The teachings herein may be applied to other types of actuator assemblies having a moveable element susceptible to damage which could prevent its movement and door opening. Moveable elements may include foldable linkages, pivotable linkages, lever(s), cables and cable drums configurations, rack and pinions configurations, gear mechanisms, spindle mechanisms. The closure panels may include liftgates, tailgates, frunk closure panels, sliding doors without limitation.

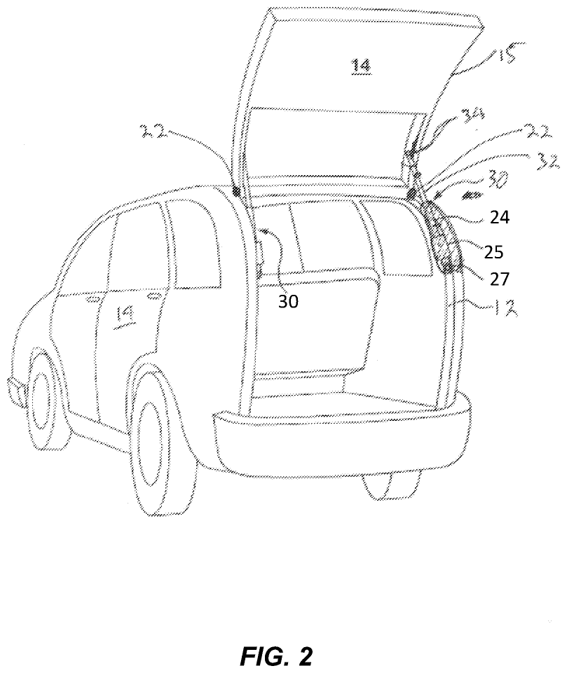

For vehicles 10, the closure panel 14 can be referred to as a partition or door, typically hinged, but sometimes attached by other mechanisms such as tracks, in front of an opening which is used for entering and exiting the vehicle 10 interior by people and/or cargo. In terms of vehicles 10, the closure panel 14 may be a driver/passenger door, a lift gate (see FIG. 2), or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening in the vehicle body 12 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening. Canopy doors are a type of door that sits on top of the vehicle 10 and lifts up in some way, to provide access for vehicle passengers via the opening (e.g. car canopy, aircraft canopy, etc.). Canopy doors can be connected (e.g. hinged at a defined pivot axis and/or connected for travel along a track) to the vehicle body 12 of the vehicle at the front, side or back of the door, as the application permits. It is recognized that the vehicle body 12 can be represented as a body panel of the vehicle 10, a frame of the vehicle 10, and/or a combination frame and body panel assembly, as desired.

The closure panel 14 (e.g. occupant ingress or egress controlling panels such as but not limited to vehicle doors and lift gates/hatches) can be connected to the vehicle body 12 via one or more hinges 22 (see FIG. 3, 9,10) and the latch assembly 20 (e.g. for retaining the closure panel 14 in a closed position once closed). It is also recognized the hinge 22 can be configured as a biased hinge 22 that can be configured to bias the closure panel 14 away from the open position (shown in FIGS. 1,2) and/or towards the open position. In terms of a biased hinge 22, used in combination with the electric linear actuator assembly 30, the biased hinge 22 can provide for assistance in presenting the closure panel 14 beyond where a ratchet of the latch assembly 20 can influence positioning of the closure panel 14 (i.e. via operation of electric linear actuator assembly 30 as further described below). It is also recognized that the biased hinge 22 can be configured as a door check mechanism integrated into the hinge and/or an independent door check assembly providing the bias.

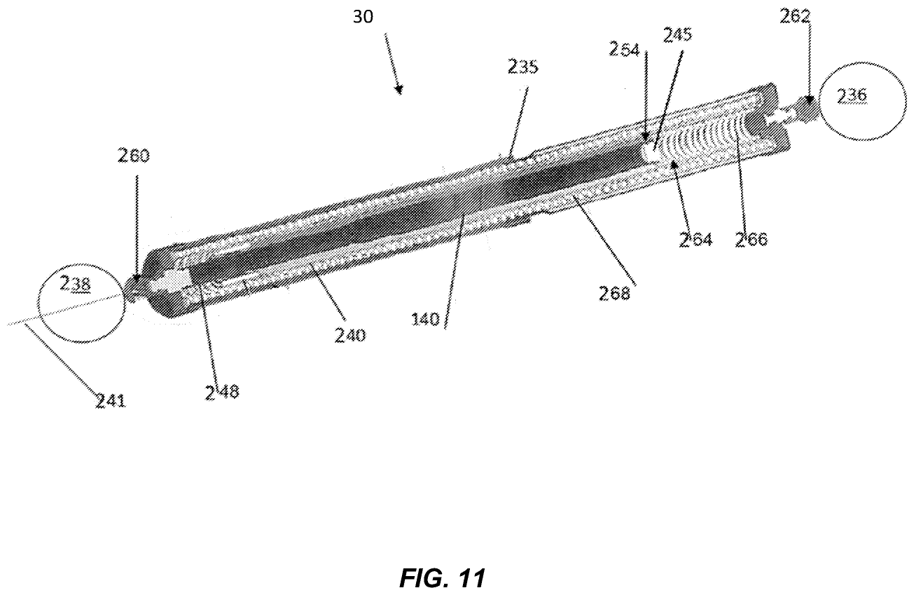

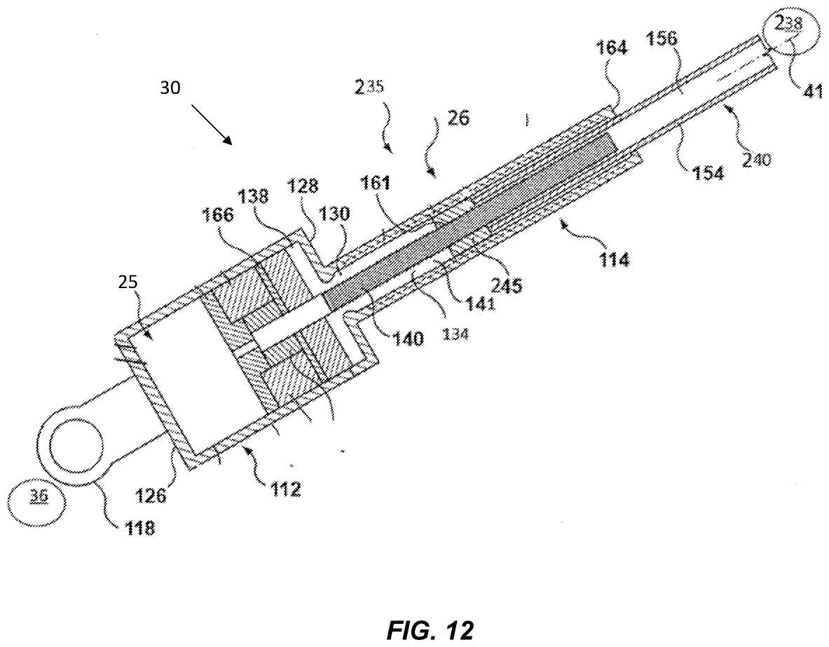

Referring to FIGS. 3 to 8, shown is one embodiment of the electric linear actuator assembly 30 for power opening/closing of the closure panel 14 (e.g. door). The linear actuator assembly 30 includes an extensible member 32 (for example coupled to a lead screw 24) and motor 25 (enclosed in a housing 235), see FIG. 2. For further actuator assembly 30 examples—see FIGS. 11,12. The linear actuator assembly 30 is connected between the door frame 15 and the vehicle body 12 (e.g. A or B pillar). The extendible member 32 can be connected at one end by a pivot point 34 (e.g. location 28) and at another end by a pivot point 27 (e.g. location 27) to the vehicle body 12.

Referring to FIGS. 3 and 9, 10, the pivot point 27 (and/or pivot point 34) can include a body connector 80, an actuator connector 82 and a connection element 84 (e.g. a pin). As such, the body connector 80 is affixed to the vehicle body 12 and the actuator connector 82 is affixed to the actuator assembly 30 (e.g. on the end of the lead screw 24 or extensible member 32). Further, the connection element 84 (e.g. a removable pin, an exploding bolt, etc.) is used to releasably secure the actuator connector 82 to the body connector 80, for example as further described below. It is also recognised that the connectors 80, 82 and connection element 84 can be assembled at pivot point 34 and/or at pivot point 27, as desired. Further, it is recognised that the extensible member 32, or the lead screw 24, can be directly connected to the respective pivot point 27, 34. In other words, depending upon the configuration, the lead screw 24 (if used) or the extensible member 32 (if used) can have the actuator connector 82 affixed thereto. It is recognised that one embodiment of the connector(s) 80,82 is an eyelet, such that once the connectors 80, 82 are aligned, the connection element 84 as a pin or bolt is positioned along the aligned connectors to thus releasably secure the connectors 80,82 to one another. In other words, the presence of the connection element 84 simultaneously overlapping, or otherwise simultaneously coupled, to each of the connectors 80, 82 results in the connection between the connectors 80, 82 being secured. Alternatively, when the connection element 84 is removed from the connectors 80, 82 (e.g. the pin or bolt is removed from simultaneously overlapping the eyelets of the connectors 80, 82), then the connector 80 is released or otherwise disconnected from the connector 82. As such, the coupling between the connectors 80,82 is of a releasable secure connection/coupling, depending upon whether the connection element 84 is present in the connection shown illustratively as a pivot connection 27,34. For example, a secured pivot connection 27 comprises the connector 80 coupled to the connector 82 by way of the connection element 84, hence the body connector 80 is releasably secured to actuator connector 84. Alternatively, when the connection element 84 is removed from the pivot connection 27, then the body connector 80 is released from the actuator connector 84.

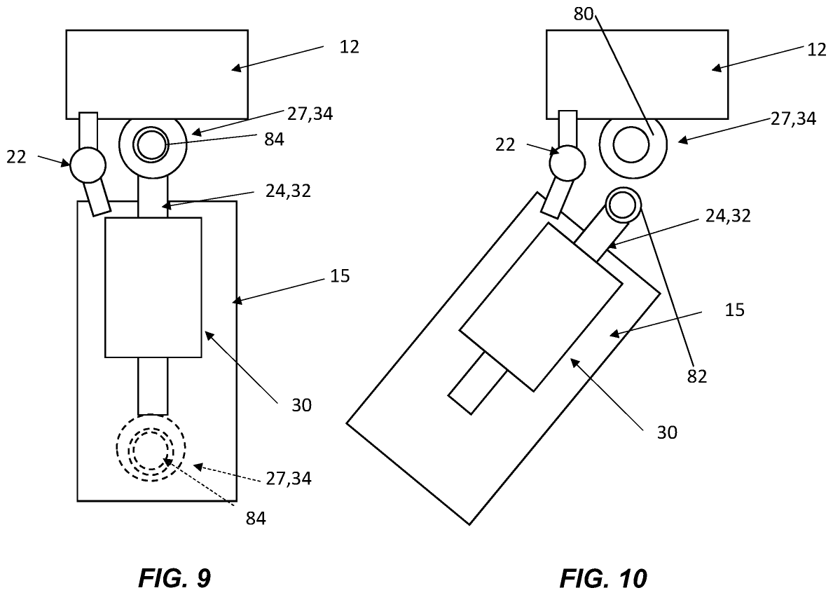

In an alternative embodiment, shown in ghosted view in FIG. 9, the body connector 80 is affixed to the door frame 15 and the actuator connector 82 is affixed to the actuator assembly 30 (e.g. on the end of the lead screw 24 or extensible member 32).

When releasably secured as the pivot connection 27, the actuator assembly 30 is coupled to the vehicle body 12. When released as the pivot connection 27, the actuator assembly 30 is uncoupled from the vehicle body 12. Alternatively, when releasably secured as the pivot connection 34, the actuator assembly 30 is coupled to the door frame 15. Alternatively, when released as the pivot connection 34, the actuator assembly 30 is uncoupled from the door frame 15. Further described below i, example process(es) by which releasably secured (i.e. coupled) and released (i.e. uncoupled) are realized. The connection element 84 causing the actuator connector 82 to transition from a coupled state to an uncoupled state does not cause the door to become completely uncoupled from the vehicle body, for example the hinged connection of the door to the vehicle body remains such that after the transition to the uncoupled state, the door may be opened normally e.g. pivoted about its hinge points.

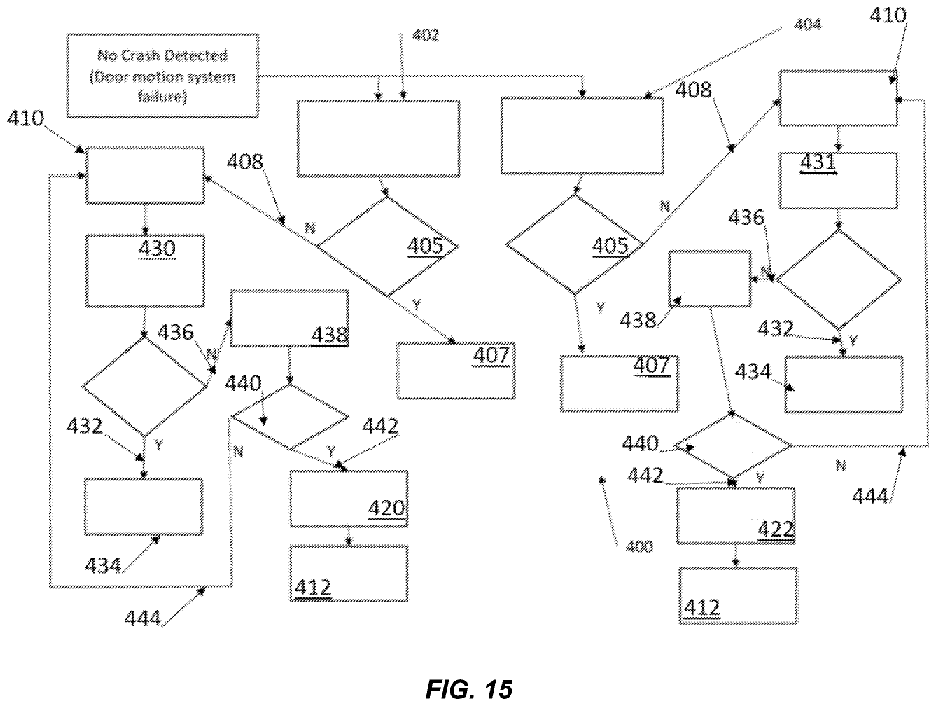

Referring again to FIG. 3, a controller 100 (e.g. body control module) can be connected to a sensor 102 (e.g. an impact detection sensor, a damage senor, an operational sensor, etc.), such that the controller 100 is used to affect the presence of the connection element 84 between/with the connectors 80, 82. In other words, the controller 100 can decide, based on a signal from the sensor 102 (e.g. a signal indicating that a crash event has occurred, that the actuator assembly is deformed, damaged or otherwise malfunctioning) whether to remove the connection element 84 from the pivot connection 27, 34 or not. In the embodiment shown in FIG. 3, a disconnection mechanism (e.g. using a plunger for example with a pyro mechanism) 86 can be activated by the controller 100 upon receipt of a signal from the sensor 102 (e.g. indicating a crash event has or otherwise will occur). Once activated by the sensor 102, the controller 100 can activate the disconnection mechanism 86 in order to effect removal of the connection element 84 from the pivot connection 27, 34 (e.g. remove the connection element 84 away from the connectors 80,82). FIG. 3 shows one embodiment of the disconnection mechanism 86 as a plunger, such that an actuation of the plunger (e.g. pyro action as a chemical mover or a motor or switch as a mechanical mover) is caused by the controller 100. A pyrotechnic a device is illustrated herein, but it is understood other manners of causing a transition of a connection from a coupled to a decoupled state may be provided, such as through use of an electrical heating device e.g. thermal, a spring released device, a motor based device, a destructive device, a chemical reaction device, or a pressure based device, as but non-limiting examples. In another possible configuration, the controller 100 may be configured to activate a disconnection when damage to the actuator 30 is detected which may be caused from a crash, or from abuse loading or mechanical failure, such as due to slamming, can also resulting in binding or otherwise malfunction of the actuator 30 (e.g. the lead screw 24) where such detection may be prior or during opening or closing of the door. (see FIG. 15). For example, the actuator unit 30 may be actuated by the controller 100 but due to damage, the controller may detect (using a position sensor (hall sensor, or encoded) in the actuator 30 or on the hinge as examples) that no corresponding door motion ensues. The controller 100 may determine that damage (e.g. malfunction of the assembly 30 itself) to the actuator assembly 30 has resulted requiring the activation of the disconnection. The controller 100 may also receive a signal from an obstacle detection system (ultrasonic, capacitive, radar, or camera based as examples—not shown) indicating to the controller 100 that no obstacle is adjacent the door 14 which is causing the failure in the opening or closing of the door 14 during attempted operation of the actuator assembly 30 by the controller 100.

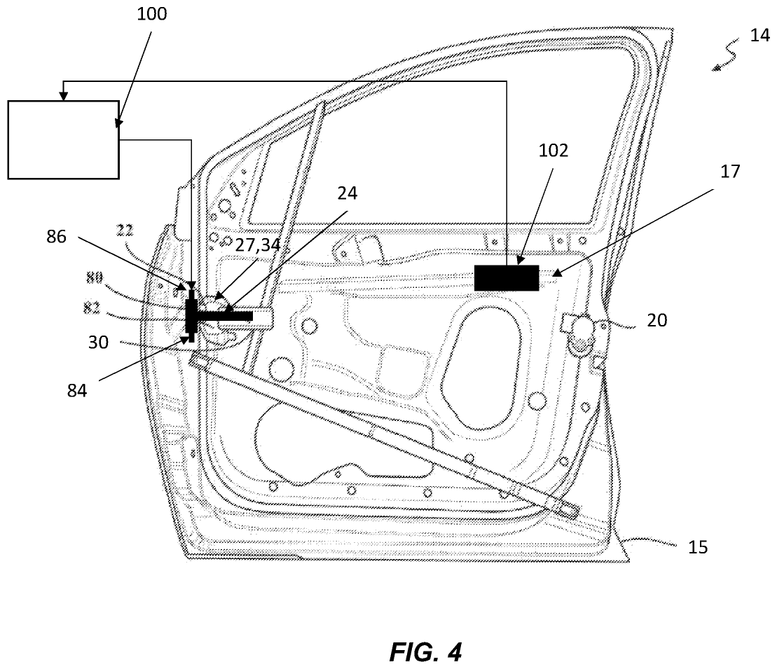

FIG. 4 shows a further embodiment of the disconnection mechanism 86 as a detonation charge for the (e.g. exploding) bolt 84 causing a pyrotechnic event, such that an actuation of the detonation charge is caused by the controller 100. For example, the disconnection mechanism 86 can be a deformable bolt 84 (e.g. deformable by chemical or mechanical means) for engagement with both connectors 80, 82 when the pivot connection 27,34 is in the coupled state. For example, the disconnection mechanism 86 can include a deform mechanism 86 such as an explosive charge or a mechanical deformation mechanism 86 for destroying the structural integrity of the bolt 84 acting as the connection element 84, such that the bolt 84 is for engagement with both connectors 80, 82 when the pivot connection 27, 34 is in the coupled state. Once the structural integrity of the bolt is 84 is destroyed, then the connectors 80, 82 can become disengaged from one another and the pivot connection is placed in the decoupled state. Thus a pyrotechnic event may cause one of the connections to transition from the coupled state to the decoupled state, and thus disconnecting the power actuator assembly 30 from one of the vehicle door and the vehicle body. For example, in the configuration of the power actuator assembly 30 provided in the vehicle door, the decoupling of the power actuator assembly 30 results in the transition of the connection between the power actuator assembly 30 and the vehicle door occurring, such that the power actuator assembly 30 remains coupled to the vehicle door and decoupled from the vehicle body. For example, in the configuration of the power actuator assembly 30 provided in the vehicle body, the decoupling of the power actuator assembly 30 results in the transition of the connection between the power actuator assembly 30 and the vehicle door occurring, where the power actuator assembly 30 remains coupled to the vehicle body and decoupled from the vehicle door.

With one of the connections in the decoupled state, the closure panel 14 may be moved towards the open position without the extensible member 32 moving. If the extensible member 32 has suffered damage, such as deformation, or bending, the door may be moved without the extensible member 32 extending or retracting for example when the extensible member is a lead screw. Due to the damage to the actuator assembly 30, for example as a result of a side impact causing an inward deformation of the outer door sheet panel, the extensible member 32 may be caused to be prevented from moving when the motor 25 is activated, or when the user manually moves the door. In a possible scenario, the deformation of the extensible member 32 may cause a locking action on the door, in that the door is neither moveable (in one direction, or both open and close directions) when the motor 25 is powered, or by user imparting a manual force on the door 14. For example, a deformation of the lead screw may prevent the lead screw from being drivingly threaded through a rotatable nut. For example, a deformation of the lead screw may prevent the lead screw from being moved through an aperature in the shut face of the vehicle. For example, a deformation of the lead screw may cause the lead screw to engage a surrounding component prevent its rotation. For example, a deformation of the lead screw may prevent advancement or retraction of a moveable nut when the lead screw is rotated without translation of the lead screw. For example, a deformation of a linkage connected to such a moveable nut may prevent the door from opening under power of the motor 25. The actuator assembly thus is not manually driven e.g. forward driven or backdriven by a user manually moving the door with one of the connections in the decoupled state since the door has been disconnected from the vehicle body via the actuator assembly with the one of the connections in the decoupled state. The hinged connections of the closure panel to the vehicle body may remain coupled. Similarly, following an emergency event the deformation or damage of the extensible member, the motor 25 of the actuator assembly 30 may not be able to move the door. For example the deformation or damage of the extensible member may result in a stall condition of the motor. Other damage to parts of the actuator assembly 30 may result in the actuator assembly 30 being unable to move the door, such as damage to a geartrain, damage to a shaft, damage to a housing, damage to a bushing, damage to a linkage, as but only non-limiting examples which prevents the door from being manually moved by a user. Following the detection of a crash event, or emergency event, such as by a vehicle controller 100 e.g. a Body Control Module, or BCM, in one possible configuration the controller 100 may assume that a deformation has occurred and cause a disconnection of the actuator assembly 30 from the vehicle body in response to a trigger event e.g. upon subsequent detection of a handle activation during an emergency mode of the controller initiated by the emergency event. In another possible configuration the controller 100 may perform a test to verify that a deformation has occurred prior to the disconnection of the actuator assembly 30 from the vehicle body e.g. initiating the disconnection mechanism 86. For example the controller 100 may power the motor of the actuator assembly 30 to determine if there is movement imparted to the extensible member 32 or not. Such motion may be determined by monitoring for a stall condition of the motor 25, monitoring if there is movement of the extensible member 32, monitoring if there is movement of the motor or gear train assembly of the actuator assembly 30, or by monitoring if there is movement of the closure panel 14 about its hinges. Associated sensors or sensing configurations may be provided for monitoring such illustrative movements to determine if the extensible member 32 has been damaged. If controller 100 determines damage has occurred, for example after operating the motor 25 not resulting in movement of the door 14 towards the open position, the disconnection mechanism 86 may be activated. Performing a test following a detected crash event may avoid unnecessarily causing a disconnection of the actuator assembly, for example when a crash detected is a result of a minor incident only causing a bumper crack; an incident thus unrelated to the side door. In a further aspect, a dedicated sensor in the door may be provided to detect a direct incident on the door likely to cause damage to the actuator assembly. A crash or emergency event may be detectable using an accelerometer as one possible example.

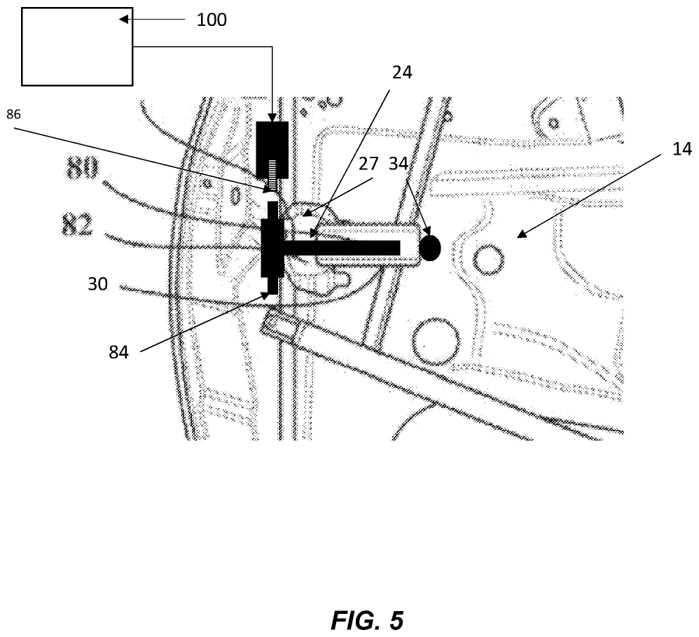

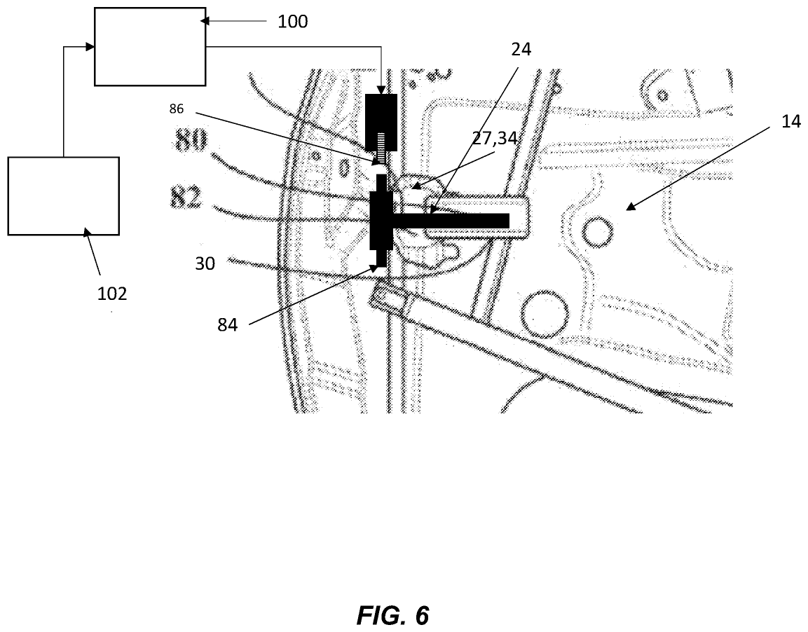

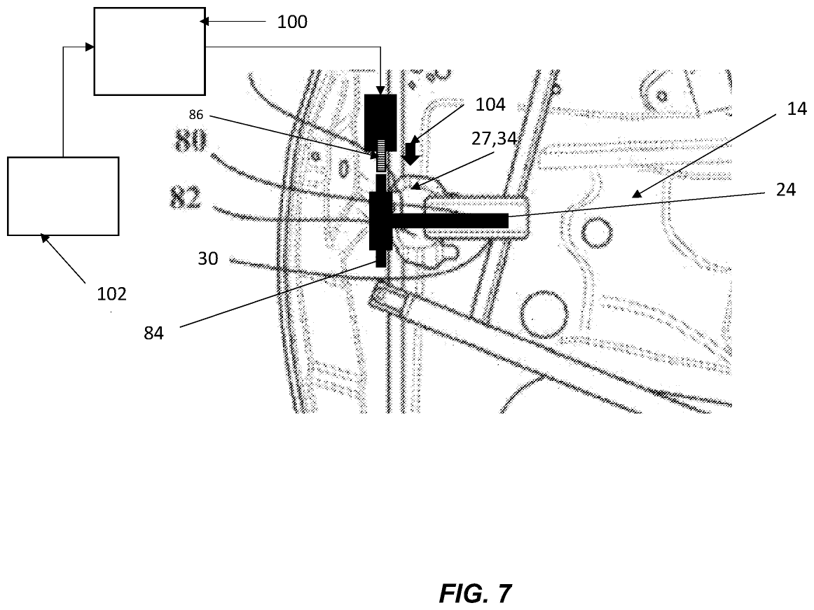

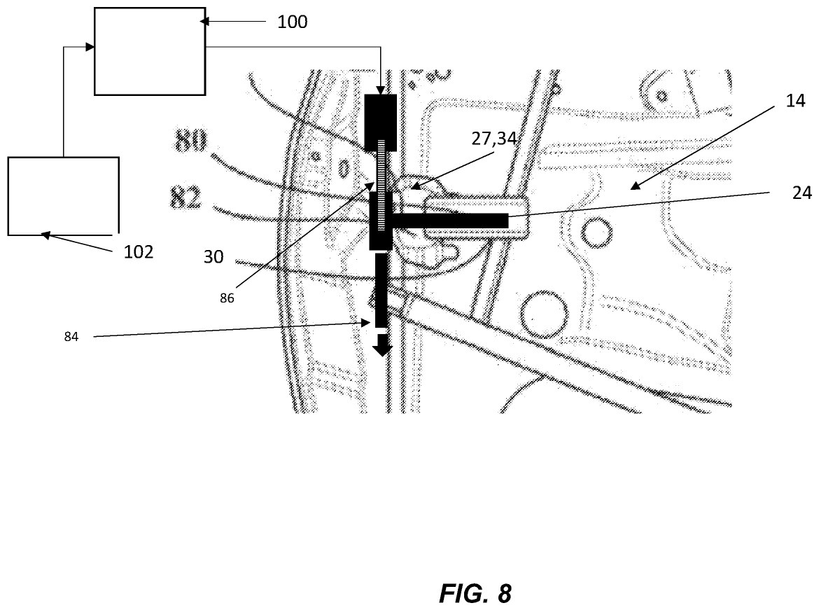

Referring to FIG. 5, shown in an unactivated position (e.g. in normal mode before a crash/emergency such that the lead screw 24 is connected to the body) is the disconnection mechanism 86 including the plunger. As such, the pivot connection 27, 34 is secured as it includes both connectors 80, 82 coupled to one another by the connection element 84, prior to the detection of a crash event. Referring to FIG. 6, shown in an activated state is the disconnection mechanism 86 including the plunger. As such, the pivot connection 27, 34 is secured as it includes both connectors 80, 82 coupled to one another by the connection element 84, however the sensor 102 has sent a signal to the controller 100 to indicate the detection of the crash event or other damage/malfunction of the actuator assembly 30. Referring to FIG. 7, shown in the activated position (e.g. in crash mode, for example after a timeout period using a controller timer, the lead screw is disconnected from the vehicle body to provide for the door to be opened without having to back drive the motor) is the disconnection mechanism 86 including the plunger. As such, the pivot connection 27, 34 is still secured as it includes both connectors 80, 82 coupled to one another by the connection element 84, however a force 104 is being applied to the connection element 84 by movement of the plunger. Referring to FIG. 8, shown in a post activated position (e.g. the plunger is moved against the pin to disengage the pivot connection from the lead screw and the hinge) is the disconnection mechanism 86 including the plunger. As such, the pivot connection 27, 34 is now released as it includes only connectors 80, 82 uncoupled to one another due to the removal of the connection element 84, post detection of the crash event.

In view of the above and further in view of FIG. 4, it is recognised that a similar disconnection process can be achieved by the embodiment of an exploding bolt as the disconnection mechanism 86.

Referring to FIG. 9, shown is the pivot connection 27,34 releasably secured (e.g. coupled) by the connection element 84 engaged with both the door connector 82 and the body connector 80, such that the actuator assembly 30 is coupled to the vehicle body 12. It is recognised that in this case, the actuator assembly 30 is connected to the door frame 15 by pivot connection 34 (see FIG. 5). Referring to FIG. 10, shown is the pivot connection 27,34 unsecured (e.g. decoupled) by the connection element 84 as it is disengaged with both the door connector 82 and the body connector 80, such that the actuator assembly 30 is decoupled to the vehicle body 12.

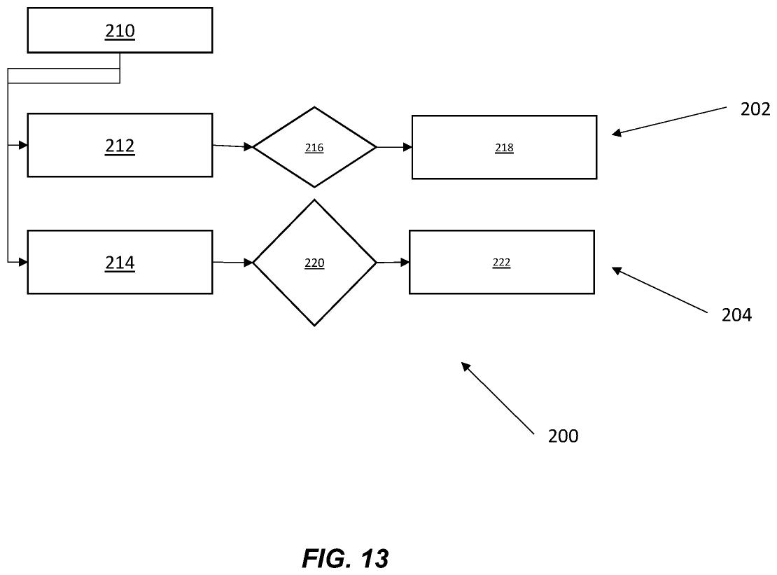

Referring to FIG. 13, shown is a method 200 for detection of the damage/malfunction event and subsequent release of the pivot connection 27, as shown by example in FIGS. 9, 10. It is recognised that a method of automatic release 202 (e.g. detect crash and start timer such that once the timeout period has expired the controller disengages the actuator from the vehicle body) of the pivot connection 27,34 can be done after an optional time out period, once the crash is detected. Alternatively, is recognised that a method of manual release 204 (e.g. wait for the manual handle release signal and if the handle release signal is detected then the controller acts to disengage the actuator from the vehicle body) of the pivot connection 27,34 can be done after waiting and received (by the controller 100) a door open signal (e.g. due to operation of the handle 16,17— See FIG. 1), e.g. once the crash is detected. Method 200 illustratively includes the steps of detecting a crash event 210. Detection of the crash event 210 may follow initiation of a timer in step 212, or alternatively standby state waiting for a trigger signal, such as for example waiting for a handle release signal to be detected in step 214. From step 212, following determining if a time out period has expired in step 216, the method 200 may continue to control the disconnection mechanism to disengage actuator assembly from vehicle body/door in response to the tine out period expiring in step 218. From step 214, following determining of a trigger event, such as if a handle release request has been detected e.g. due to a handle pull, at step 220, the method 20 continues to step 222 to control the disconnection mechanism to disengage actuator assembly from vehicle body/door in response to the detection of the trigger event.

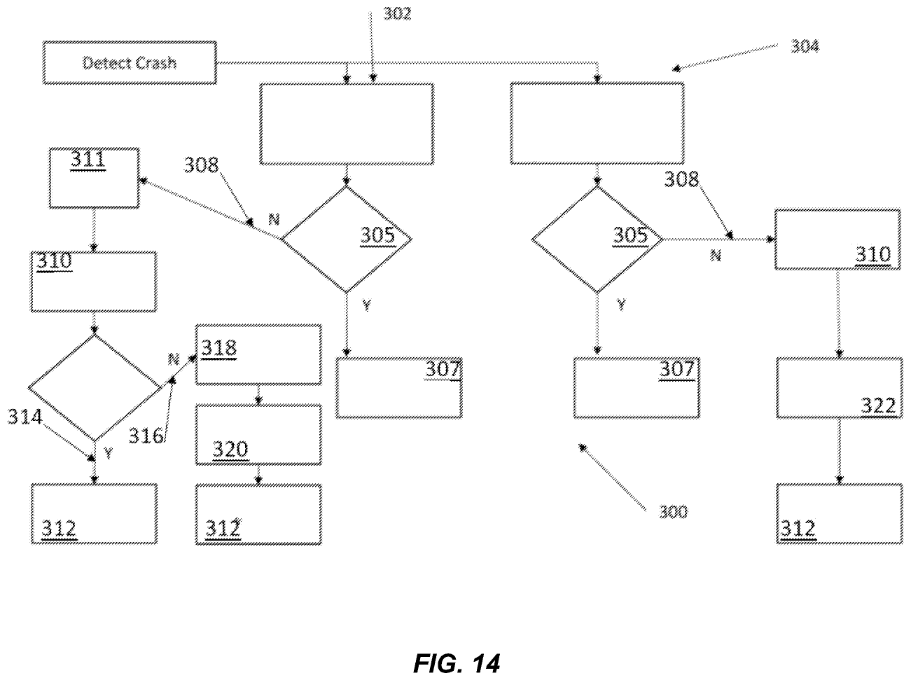

Referring to FIG. 14, shown is a further method 300 for opening the door 14 depending upon whether the exterior handle 17 process is used 304 or the interior handle 16 process is used 302. In both situations, if the controller 100 is informed 305 (e.g. by a door open signal from a door sensor—not shown) that the door 14 opened normally 307 (i.e. with the pivot connection 27, 34 secured), then there is no need to remove the connection element 84 from the pivot connection 27,34. On the other hand, if the controller 100 is informed 305 (e.g. by a door open signal from a door sensor—not shown) that the door 14 did not open normally 308 for example due to a detected crash event (i.e. with the pivot connection 27, 34 secured), then the controller 100 sends a signal 310 (in the case of process 302 after a timer is started 311 to remove 312 the connection element 84 from the pivot connection 27,34, (i.e. go from a coupled state of FIG. 9 to a decoupled state of FIG. 10) in order to facilitate subsequent opening of the door 14. It is recognised that the portrayed alarms and timer steps can be optional. In the case of process 302, if the driver requests 314 a decoupling from the door then the decoupling 312 occurs. Alternatively if the driver did not request 316, then the timer first expires 318, an alarm is sounded 320 and then the unit is decoupled 312. For the process 304, after the signal is transmitted 310 to the controller, then the alarm is sounded 322 and the unit is then decoupled 312. The method 300 illustratively includes the step of detecting a crash 306. The method may proceed to step 308 of detecting a handle release signal (interior) as an example of a conscious driver situation. The method may proceed to step 310 of detecting a handle release signal (exterior) 310 as an example of a conscious driver situation. From step 308, the method 300 may proceed to determine an attempt Power Open in step 312. If an open is not achieved, the method may proceed to step 314 to initiate a timer and indicate a no open signal or alert to the driver in step 316. The method may proceed from step 316 to step 318 of determining if there is a driver request to decouple the actuator assembly from the door. From step 318 the method 300 may continue in step 319 to decouple the actuator assembly from the door. The method may proceed from step 316 to step 320 of waiting for a timer to expire (for example if a driver becomes unconscious after crash). From step 320 the method 300 may continue in step 322 to sound an alarm, and to decouple the actuator assembly from the door in step 324. If an open is not achieved at step 312, the method may proceed to step 326 to determine door is open and no response is needed.

Referring to FIG. 15, shown is a further method 400 for opening the door 14 depending upon whether the exterior handle 17 process is used 404 or the interior handle 16 process is used 402. In both situations, if the controller 100 is informed 405 (e.g. by a door open signal from a door sensor—not shown) that the door 14 opened normally 407 (i.e. with the pivot connection 27, 34 secured), then there is no need to remove the connection element 84 from the pivot connection 27,34. On the other hand, if the controller 100 is informed (e.g. by a door open signal from a door sensor—not shown) that the door 14 did not open normally 408 for example due to a detected malfunction of the intended operation of the actuator assembly 30 (e.g. as instructed by the controller 100, with the pivot connection 27, 34 secured), then the controller 100 sends the disconnection signal 410 to eventually remove 412 the connection element 84 from the pivot connection 27,34, (i.e. go from a coupled state of FIG. 9 to a decoupled state of FIG. 10) in order to facilitate subsequent opening of the door 14, prior to sounding an alarm 420, 422. It is recognised that the portrayed alarms and timer steps can be optional.

Further, for example for the process 402, if after the signal 410 is received, the controller 100 can check 430 if all doors are open or closed. In the case where another door was opened 432 by the car occupant, then the fault signal (e.g. signal 410) remains on and the power door function is disabled 434. Alternatively, of the occupant did not 436 exit via one of the doors then the occupant is asked 438 if decoupling of the door is desired. Upon receipt of the occupant response 440, if yes 442 then the alarm is sounded 420 and door decoupled 412. Alternatively, if no 444, then the system returns to await for a further sending of the disconnection signal at step 410.

Further, for example for the process 404, if after the signal 410 is received, the controller 100 can check 431 if all doors are open or closed. In the case where another door was opened 432 by the car occupant, then the fault signal (e.g. signal 410) remains on and the power door function is disabled 434. Alternatively, of the occupant did not 436 exit via one of the doors then the occupant is asked 438 if decoupling of the door is desired. Upon receipt of the occupant response 440, if yes 442 then the alarm is sounded 422 and door decoupled 412. Alternatively, if no 444, then the system returns to await for a further sending of the disconnection signal at step 410.

The method 400 can be useful in cases where something could be broken or otherwise non-functional in the actuator assembly 30 (e.g. without the vehicle experiencing a crash event), which won't allow the door 14 to move. It could also be that the actuator assembly 30 is functional however some adjacent component of the vehicle or other foreign object is interfering with the successful opening/closing of the door under the assistance of the actuator assembly 30.

For example, damage or a damage event can refer to different situations, for example: a crash event, determined malfunction of the actuator assembly 30; damage to the actuator assembly 30; and/or an impingement or otherwise deemed interference with the operation of the actuator assembly 30.

It is recognised that the methods 200, 300, 400 could also be applied to closing of the door, i.e. the door was successfully opened but then would refuse to obey the command (from the controller 100) to close.

FIGS. 11 and 12 show an example configuration for the linear actuator assembly 30 of FIG. 3, for example a spring loaded strut. A housing 235 also contains an extension member 240 (e.g. extensible member 32) used to extend from, or retract within, the housing 235 to effect the resulting location of the closure panel 14 with respect to the door frame 15. For example, an extended extension member 240 results in positioning the closure panel 14 in the extended/open state, while a retracted extension member 240 results in positioning the closure panel 14 in a retracted/closed state with respect to the vehicle body 12. It is recognized that the linear actuator assembly 30 can be implemented as a strut. The linear actuator assembly 30 can be of a biasing type (e.g. spring and/or gas charge supplying the bias). In one further example, see FIG. 12, the extension member 240 is actively driven by via a lead screw 140 (e.g. lead screw 24). The extension member 240 is either extended from, or retracted into, the housing 235. It is recognized that the linear actuator assembly 30 can have the lead screw 140 (e.g. rotary output member—see FIG. 12) operated actively (i.e. driven) by the motor 25 (e.g. electrical).

Referring to FIGS. 2, 11, 12, shown is the linear actuator assembly 30 with the body 235 (e.g. housing) having a first end 260 for connecting via pivot point 27 (e.g. point 238) and a second end 262 for connecting to the closure panel 14 at fixed mount, also referred to by reference numeral 236. In this configuration, the linear actuator assembly 30, by example only, has the extension member 240 (e.g. a stator member slideably engageable with a rotary output member such as via mated threads) positioned in an interior 264 of the housing 235. A distal end of 254 the extension member 240 is coupled to the second end 262 (for example via an optional element 266—spring) and the proximal end 248 of the extension member 240 is coupled to the first end 260. The extension member 240 is coupled to the lead screw 140 via a travel member 245 (for example as an integral part of or separate to the extension member 240), such that rotation of the lead screw 140 causes travel of the travel member 245 along the lead screw 140, to result in extension or retraction of the extension member 240 with respect to the housing 235. As discussed in relation to FIG. 12, the travel member 245 and the lead screw 140 are coupled to one another via mated threads. As shown, the linear actuator assembly 30 can be a strut having a resilient element of the power spring 268 for providing the counterbalance torque (T) during operation of the closure panel 14 in moving between the extended and retracted positions.

Referring again to FIGS. 11, 12, the travel member 245 is positioned at one end of the extension member 240. The extension member 240 is coupled (in this example case via a mounted kicker spring 266) to the housing 235 at the distal end. Complimentary, the extension member 240 is coupled at the proximal end. As such, as the extension member 240 is displaced along the longitudinal axis 241, the attached travel member 245 is displaced along the lead screw 140. As such, as the closure panel 14 is moved between the extended and retracted positions, the position of the travel member 245 along the lead screw 140 varies, thereby providing for reciprocation of the travel member 245 along the longitudinal axis 241 of the lead screw 140.

Referring now to FIG. 12, the embodiment of the linear actuator assembly 30 is shown including the housing 235 having a lower housing 112 and an upper housing 114 for containing the extension member 240 (e.g. extensible shaft/rod). Fixed mount 118 is attached to an end wall 126 of lower housing 112 proximal to the door frame 15. Upper housing 114 provides a (e.g. cylindrical) sidewall 141 defining a chamber 134 that is open at both ends. A distal end wall 128 of lower housing 112 includes an aperture 130. The lead screw 140 (or referred to as a lead screw 140 or rotary output member powered by rotary motion of the motor 25) which can be used to transport or otherwise guide the travel member 245 (connected to the extension member 240) along the longitudinal axis 41. For example, the travel member 245 contains an internally facing series of threads in bore 161 that are mated to an externally facing series of threads on the extension member 240, as desired. Extensible member 240 provides a cylindrical sidewall 154 defining a chamber 156 and can be concentrically mounted between upper housing 114 and lead screw 140. As described earlier, pivot mount 238 (i.e. pivot point 27) is attached to the distal end of extensible member 240. The nut 245 (also referred to as the travel member 245) is mounted around the proximal end of extensible member 240 relative to lower housing 112 and is coupled with lead screw 140 in order to convert the rotational movement of lead screw 140 into the linear motion of the extensible member 240 along the longitudinal axis 41 of lead screw 140. The nut 245 can include splines that extend into opposing coaxial slots provided on the inside of upper housing 114 to inhibit nut 245 from rotating as the nut 245 travels along the longitudinal axis 41. Alternatively, the nut 245 may be configured without the splines and thus be free to rotate as the nut 245 travels along the longitudinal axis 41, without departing from the scope of the description. An integrally-formed outer lip 164 in upper housing 114 can provide an environmental seal between chamber 134 and the outside.

A spring housing 138 can be provided in lower housing 112 and defined by cylindrical sidewall 122, end wall 128, and a flange 166. Within spring housing 138, a power spring (not shown in FIG. 12) similar to the power spring 268 as seen in FIG. 11 can be optionally coiled around lead screw 140, providing a mechanical counterbalance to the weight of the closure panel 14. One end of power spring 268 is positioned or otherwise attached to the travel member 245 and the other is secured to a portion of cylindrical sidewall 122. When extensible member 240 is in its retracted position, power spring 268 is tightly coiled around lead screw 140 and therefore applies bias against the travel member 245. As lead screw 140 rotates to extend extensible member 240, in concert with travel of the travel member 245 along the upper housing 114, power spring 268 uncoils, releasing its stored energy and transmitting an axial force through extensible member 240. When power screw 140 rotates to retract extensible member 240, in concert with travel of the travel member 245 along the upper housing 114, power spring 268 recharges by recoiling around lead screw 140. Also shown in FIG. 12 are the mating threads between those of the travel member 245 and those of the lead screw 140.

While the above description constitutes a plurality of embodiments, it will be appreciated that the present disclosure is susceptible to further modification and change without departing from the fair meaning of the accompanying claims.

We claim:

1. A system for releasably securing a linear actuator assembly (30) to a vehicle closure panel (14) comprising:
the linear actuator assembly coupled at one end to a door frame (15) by a first pivot connection (34) and coupled at a second end to the vehicle body (12) by a second pivot connection (27), the actuator assembly having an extensible member (32) configured for extension and retraction in order to facilitate opening and closing of the closure panel with respect to the vehicle body; and
at least one of the pivot connections having an actuator connector (82) connected to the extensible member and a body connector (80) connected to either the vehicle body or the door frame, such that when in a coupled state a connection element (84) secures the body connector to the actuator connector; and
a disconnection mechanism (86) for removing the connection element from the connectors in response to a detection of a door malfunction event.

2. The system of claim 1 further comprising a controller (100) for controlling operation of the disconnection mechanism in response to the detection of the door malfunction event as a damage event.

3. The system of claim 1 further comprising a crash sensor (102) for supplying said detection.

4. The system of claim 1, wherein the disconnection mechanism is a plunger mechanism positioned adjacent to the connection element and the connection element is a pin for engagement with both connectors when the at least one of the pivot connections is in the coupled state.

5. The system of claim 1, wherein the disconnection mechanism is a deformable bolt for engagement with both connectors when the at least one of the pivot connections is in the coupled state.

6. The system of claim 1, wherein the disconnection mechanism is a deform mechanism for a bolt acting as the connection element, such that the bolt is for engagement with both connectors when the at least one of the pivot connections is in the coupled state.

7. The system of claim 6, wherein the deform mechanism is an explosive charge.

8. The system of claim 1, wherein the body connector is connected to the vehicle body.

9. The system of claim 1 further comprising the linear actuator including a lead screw (24) coupled to the extensible member.

10. A method for releasably securing a linear actuator assembly to a vehicle closure panel, the method comprising:
providing the linear actuator assembly coupled at one end to a door frame by a first pivot connection and coupled at a second end to a vehicle body by a second pivot connection, at least one of the pivot connections having an actuator connector connected to the linear actuator assembly and a body connector connected to either the vehicle body or the door frame, such that when in a coupled state a connection element secures the body connector to the actuator connector;
receiving a event signal indicating a door malfunction event; and
instructing a disconnection mechanism for removing the connection element from the connectors in response to said event signal;
wherein the at least one of the pivot connections is placed in a decoupled state by disengagement of the body connector from the actuator connector when the connection element is removed.

11. A system for releasably securing an actuator assembly (30) connected to a vehicle closure panel (14) and to a vehicle body (12), the system comprising:
the actuator assembly coupled to the vehicle closure panel (14) by a first connection and coupled at a second end to a vehicle body (12) by a second connection, the actuator assembly having an extensible member (32) configured for movement in order to facilitate opening and closing of the closure panel with respect to the vehicle body;
wherein one of the connections has a coupled state to secure the actuator assembly to one of the vehicle closure panel and the vehicle body and has a decoupled state to unsecure the actuator assembly from one of the vehicle closure panel and the vehicle body, the decoupled state allowing the closure panel to open without the extensible member moving.

12. The system of claim 11, wherein one of the connections is transitioned from the coupled state to the decoupled state in response to a pyrotechnic event.

13. The system of claim 12, wherein one of the connections comprises a bolt, wherein the bolt comprises a pyrotechnic device adapted to explode.

14. The system of claim 12, wherein the pyrotechnic event is controlled by a controller.

15. The system of claim 14, wherein the controller is adapted to initiate the pyrotechnic event following the detection of an emergency event.

16. The system of claim 15, wherein the controller is adapted to initiate the pyrotechnic event in response to detection of a door open signal following the detection of the emergency event.

17. The system of claim 11, wherein the first connection is a pivot connection for coupling the extensible member to the vehicle body when in the coupled state, and the second connection is another pivot connection for coupling the actuator assembly to the closure member, wherein the first connection is adapted to have the uncoupled state.

18. The system of claim 17, wherein a deformable bolt is provided with the first pivot connection, the deformable bolt adapted to deform in response to an explosion to unsecure the extensible member from the vehicle body.

19. The system of claim 11 further comprising the actuator including a lead screw (24) coupled to the extensible member.

20. The system of claim 11, wherein the actuator assembly comprises a motor for moving the extensible member, wherein with one of the connections in the decoupled state the closure panel is manually moveable without powering the motor.
